(19) United States
(12) Patent Application Publication
(10) Pub. No.: US 2026/0121507 A1
(43) Pub. Date: Apr. 30, 2026

(54) POWER SUPPLY UNIT AND OPERATING METHOD THEREOF

(71) Applicant: DELTA ELECTRONICS, INC., Taoyuan City (TW)

(72) Inventors: Ching-Ho CHOU, Taoyuan City (TW); Yung-Chuan LU, Taoyuan City (TW)

(21) Appl. No.: 19/243,746

(22) Filed: Jun. 20, 2025

(30) Foreign Application Priority Data
Oct. 30, 2024 (CN) 202411528413.7

(51) Int. Cl. H02M 1/00; H02M 7/00; H02M 7/04; H05B 45/37

(52) U.S. Cl. CPC H02M 1/0016; H02M 7/003; H02M 7/04; H05B 45/37

(57) ABSTRACT

A power supply includes a housing, an output voltage control line, a power conversion circuit, an output control circuit, a current detection circuit, a feedback circuit, a coupling circuit and a power conversion control circuit. The power conversion circuit receives an input voltage. The feedback circuit receives a detection voltage signal and a detection current signal to correspondingly generate a control signal. The coupling circuit generates a power conversion control signal based on the control signal. The power conversion control circuit generates a conversion signal based on the power conversion control signal. When the output voltage control line is conducted, the output control circuit sets the power conversion circuit to correspondingly generate a first output voltage. When the output voltage control line is not conducted, the output control circuit sets the power conversion circuit to correspondingly generate a second output voltage.

### CROSS-REFERENCE TO RELATED APPLICATIONS

This application claims priority to Chinese Application Serial Number 202411528413.7, filed Oct. 30, 2024, which is herein incorporated by reference in its entirety.

### BACKGROUND

### Technical Field

The present disclosure relates to a power supply unit, and particularly relates to a power supply unit having a configurable output voltage.

### Description of Related Art

At present, there are various power specifications of light-emitting diode (LED) lamps on the market, e.g., LED lamp strings connected in series and/or in parallel in a suitable form. In addition, LED lamps also have a variety of power specifications, e.g., LED lamps with an input voltage of 12V and LED lamps with an input voltage of 24V. In order to meet different power specifications of LED lamps, power supply unit manufacturers need to produce different models of power supply units, which not only increases the complexity of material preparation and manufacturing, but also brings inventory management problems, and even causes that lamp manufacturers may damage LED lamps due to the misuse of unsuitable specifications of power supplies.

### SUMMARY

Accordingly, there is a need for an effective design for a power supply unit to solve the aforementioned technical problems.

An aspect of the present disclosure provides a power supply unit configured to supply power to a load. The power supply unit comprises a power conversion circuit, an output control circuit, a current detection circuit, a first feedback circuit, a coupling circuit, a power conversion control circuit, a housing, and an output voltage control line. The power conversion circuit comprises a first input terminal, a second input terminal, a first output terminal, and a second output terminal, wherein the first input terminal and the second input terminal are configured to receive an input voltage, and the first output terminal and the second output terminal are configured to be coupled to the load. The output control circuit is coupled to the first output terminal and has a control terminal. The current detection circuit comprises a first terminal coupled to the second output terminal of the power conversion circuit and a second terminal configured to be coupled to the load. The first feedback circuit is coupled to the first output terminal of the power conversion circuit to receive a first voltage detection signal, coupled to the current detection circuit to receive a first current detection signal, and coupled to the output control circuit to correspondingly generate a first control signal. The coupling circuit is coupled to the first feedback circuit to receive the first control signal and is configured to generate a power conversion control signal based on the first control signal. The power conversion control circuit is coupled to the coupling circuit and the power conversion circuit and is configured to generate a conversion signal based on the power conversion control signal. The housing accommodates at least one of the power conversion circuit, the output control circuit, the current detection circuit, the first feedback circuit, the coupling circuit, and the power conversion control circuit. The output voltage control line is coupled between the control terminal of the output control circuit and the first output terminal of the power conversion circuit, wherein at least a portion of the output voltage control line is exposed from the housing.

When the output voltage control line is set to be conductive, the control terminal of the output control circuit is coupled to the first output terminal of the power conversion circuit through the output voltage control line to receive a control voltage. Based on the control voltage, the output control circuit sets the first feedback circuit to generate the first control signal, and the first control signal sets the power conversion circuit to correspondingly generate a first output voltage, wherein the power conversion circuit has a first maximum output current.

When the output voltage control line is set to be non-conductive, the control terminal of the output control circuit is not coupled to the first output terminal of the power conversion circuit. The output control circuit sets the first feedback circuit to generate the first control signal, and the first control signal sets the power conversion circuit to correspondingly generate a second output voltage, wherein the power conversion circuit has a second maximum output current. The first output voltage is greater than the second output voltage, and the first maximum output current is less than the second maximum output current.

Another aspect of the present disclosure provides an operating method of a power supply unit, which is configured to supply power to a load. The power supply unit comprises a housing, an output voltage control line, a power conversion circuit, an output control circuit, a current detection circuit, a first feedback circuit, a coupling circuit, and a power conversion control circuit. The housing accommodates at least one of the power conversion circuit, the output control circuit, the current detection circuit, the first feedback circuit, the coupling circuit, and the power conversion control circuit. The power conversion circuit comprises a first input terminal, a second input terminal, a first output terminal, and a second output terminal, wherein the first output terminal and the second output terminal are configured to be coupled to the load. The output control circuit is coupled to the first output terminal and has a control terminal. The current detection circuit comprises a first terminal coupled to the second output terminal of the power conversion circuit and a second terminal configured to be coupled to the load. The first feedback circuit is coupled to the first output terminal of the power conversion circuit, the current detection circuit, and the output control circuit. The coupling circuit is coupled to the first feedback circuit. The power conversion control circuit is coupled to the coupling circuit and the power conversion circuit. The output voltage control line is coupled between the control terminal of the output control circuit and the first output terminal of the power conversion circuit, wherein at least a portion of the output voltage control line is exposed from the housing. The operating method comprises: setting the first input terminal and the second input terminal of the power conversion circuit to receive an input voltage to supply power to a load at the first output terminal and the second output terminal of the power conversion circuit; setting the first feedback circuit to receive a first voltage detection signal from the first output terminal of the power conversion circuit and to receive a first current detection signal from the current detection circuit to correspondingly generate a first control signal; setting the coupling circuit to receive the first control signal from the first feedback circuit and to generate a power conversion control signal based on the first control signal; and setting the power conversion control circuit to generate a conversion signal based on the power conversion control signal. When the output voltage control line is set to be conductive, the control terminal of the output control circuit is coupled to the first output terminal of the power conversion circuit through the output voltage control line to receive a control voltage, the output control circuit sets the first feedback circuit to generate the first control signal, and the first control signal sets the power conversion circuit to correspondingly generate a first output voltage, and the power conversion circuit has a first maximum output current. When the output voltage control line is set to be non-conductive, the output control circuit sets the first feedback circuit to generate the first control signal, the first control signal sets the power conversion circuit to correspondingly generate a second output voltage, and the power conversion circuit has a second maximum output current. The first output voltage is greater than the second output voltage, and the first maximum output current is less than the second maximum output current.

The power supply unit provided by the present disclosure is capable of setting the output voltage of the power supply unit by configuring the conductive state of the output voltage control line exposed from the housing. This not only enhances the convenience and stability of installation but also allows for the implementation of multiple power output specifications.

### BRIEF DESCRIPTION OF THE DRAWINGS

The present disclosure can be more fully understood by referring to the drawings below for a detailed description of the following embodiments:

FIG. 1 is a block diagram of an embodiment of a power supply unit according to the present disclosure;

FIG. 2A is a block diagram showing some circuits of the power supply unit in FIG. 1;

FIG. 2B is a specific circuit architecture diagram of the power supply unit in FIG. 2A;

FIG. 3 is a block diagram of another embodiment of a power supply unit according to the present disclosure;

FIG. 4A is a block diagram showing some circuits of the power supply unit in FIG. 3; and

FIG. 4B is a specific circuit architecture diagram of the power supply unit in FIG. 4A.

FIG. 5 is a perspective view of an embodiment of the housing of the power supply unit;

FIG. 6 is a block diagram of an embodiment of the power supply unit of FIG. 1 installed in the housing of FIG. 5; and

FIG. 7 is a block diagram of an embodiment of the power supply unit of FIG. 3 installed in the housing of FIG. 5.

### DETAILED DESCRIPTION

The following describes embodiments in detail with reference to the drawings. However, the specific embodiments described are only intended to illustrate the present disclosure, rather than to define the present disclosure, and the description on structure operations is not adopted to limit the order in which the structure operations are performed; and any device with an equal effect resulting from the recombination of components of the structure falls within the scope of the present disclosure.

Terms used throughout the Description and the Claims of the present disclosure, unless otherwise specified, generally have the ordinary meaning of each term used in the art, in the present disclosure and in special contents.

The term “coupling” used herein may refer to a direct physical or electrical contact between two or more components, or to an indirect physical or electrical contact between two or more components, or to an interoperation or action of two or more components.

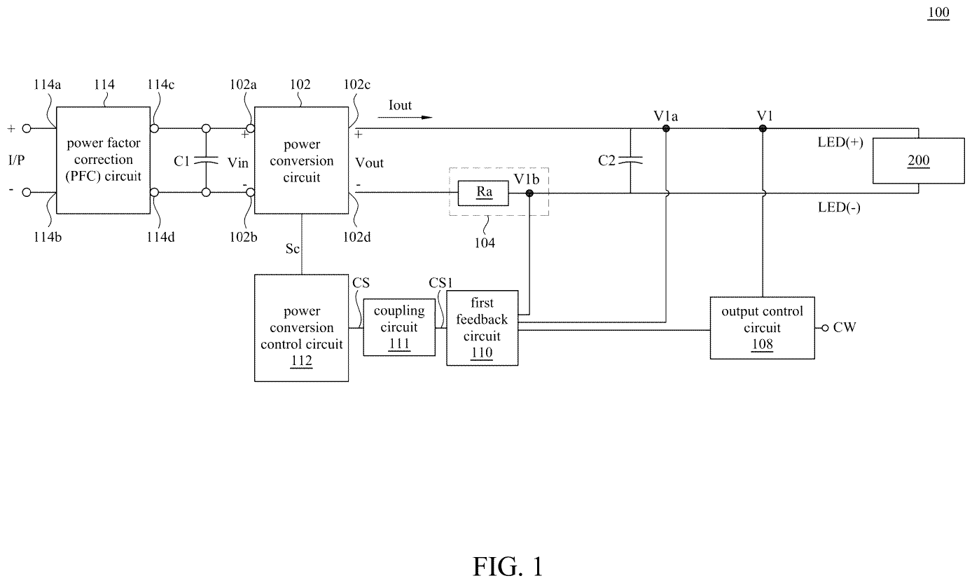

Reference is made to FIG. 1 which is a block diagram of an embodiment of a power supply unit 100 configured to supply power to a load (LED 200), according to the present disclosure. The power supply unit 100 is coupled to an anode LED (+) and a cathode LED (−) of the LED 200 to supply power to the LED 200. The power supply unit 100 includes a power conversion circuit 102, an output control circuit 108, a first feedback circuit 110, a coupling circuit 111 and a power conversion control circuit 112. In one embodiment, the LED 200 may include one or more light-emitting elements therein, and the power conversion circuit 102 may be a suitable power conversion architecture such as an isolated or non-isolated DC-DC converter, a SMPS (switch mode power supply) converter or an AC-DC converter. The first feedback circuit 110 may include elements such as a digital circuit, an analog circuit, an optocoupler and/or an optical isolator to transmit a feedback signal to the power conversion control circuit 112, so that the power conversion control circuit 112 can set the power conversion circuit 102 to generate an appropriate output voltage Vout and/or an appropriate output current Iout.

In the following embodiment, through the control of a signal level of a control terminal CW of the output control circuit 108, the output voltage Vout of the power supply unit 100 is controlled at 12V or 24V, so that the power supply unit correspondingly supplies power to the LED 200 with a voltage of 12V or the LED 200 with a voltage of 24V. In other embodiments, the output voltage Vout of the power supply unit 100 may also be set to be one of two or more other suitable voltages through the control of the signal level of the control terminal CW of the output control circuit 108.

In the present embodiment, the power conversion circuit 102 can be set to have both 12V and 24V power output specifications. When the control terminal CW is coupled to a first control voltage (e.g., high voltage), the output control circuit 108 and the first feedback circuit 110 generate and transmit a first control signal CS1 to the coupling circuit 111 based on the first control voltage, a first voltage detection signal V1a and a first current detection signal V1b, the coupling circuit 111 generates and transmits a power conversion control signal CS to the power conversion control circuit 112 based on the first control signal CS1, and the power conversion control circuit 112 generates and transmits a conversion signal Sc to the power conversion circuit 102 based on the power conversion control signal CS, so that the power conversion circuit 102 perform a power conversion operation on a power input signal (that is, input voltage Vin) based on the conversion signal Sc to set the output voltage Vout to 24V.

When the control terminal CW is not coupled to the first control voltage (e.g., floated, grounded or coupled to a suitable voltage level such as a second control voltage less than the first control voltage), the output control circuit 108 and the first feedback circuit 110 generate and transmit the first control signal CS1 to the coupling circuit 111 based on the first voltage detection signal V1a and the first current detection signal V1b, the coupling circuit 111 generates and transmits the power conversion control signal CS to the power conversion control circuit 112 based on the first control signal CS1, and the power conversion control circuit 112 generates and transmits the conversion signal Sc to the power conversion circuit 102 based on the power conversion control signal CS, so that the power conversion circuit 102 perform a power conversion operation on the input voltage Vin based on the conversion signal Sc to set the output voltage Vout to 12V.

The power conversion circuit 102 includes a first input terminal 102a, a second input terminal 102b, a first output terminal 102c and a second output terminal 102d. The first input terminal 102a and the second input terminal 102b are configured to receive the input voltage Vin. The first output terminal 102c and the second output terminal 102d are configured to be coupled to the LED 200 to output a first voltage V1 to the LED 200. The first output terminal 102c is configured to be coupled to the anode LED (+) of the LED 200. The input voltage Vin can be an AC voltage or a DC voltage.

In one embodiment, the power supply unit 100 further includes a power factor correction (PFC) circuit 114 and a first capacitor C1. The PFC circuit 114 includes a first AC input terminal 114a, a second AC input terminal 114b, a first PFC output terminal 114c and a second PFC output terminal 114d. The first PFC output terminal 114c and the second PFC output terminal 114d are coupled to the first input terminal 102a and the second input terminal 102b respectively. The first AC input terminal 114a and the second AC input terminal 114b receive an original voltage I/P to generate the input voltage Vin to the first input terminal 102a and the second input terminal 102b. A first terminal of the first capacitor C1 is coupled to the first PFC output terminal 114c and the first input terminal 102a, and a second terminal of the first capacitor C1 is coupled to the second PFC output terminal 114d and the second input terminal 102b. Therefore, through the above circuit structure, the power conversion circuit 102 receives the input voltage Vin. In one embodiment, the original voltage I/P may be an AC voltage.

In one embodiment, the power supply unit 100 does not include the PFC circuit 114 and the first capacitor C1, and the first input terminal 102a and the second input terminal 102b of the power conversion circuit 102 directly receive the original voltage I/P.

In the present embodiment, the power supply unit 100 further includes a current detection circuit 104 which is coupled to the second output terminal 102d and the cathode LED (−) of the LED 200, and coupled to the first output terminal 102c and the anode LED (+) of the LED 200 via a second capacitor C2. The current detection circuit 104 includes a first voltage across resistor Ra, a first terminal of the first voltage across resistor Ra is coupled to the second output terminal 102d, and a second terminal of the first voltage across resistor Ra is coupled to the cathode LED (−) of the LED 200. Since voltage across both ends of the first voltage across resistor Ra is positively correlated with a current flowing through the first voltage across resistor Ra, a voltage value of the first voltage across resistor Ra can be used as the first current detection signal V1b to detect a value of a current flowing through the current detection circuit 104.

The output control circuit 108 is coupled to the first output terminal 102c and the first feedback circuit 110. In one embodiment, if the control terminal CW of the output control circuit 108 is to be coupled to the first control voltage so that the power supply unit 100 generates an output voltage Vout of 24V, the control terminal CW can be coupled to the first output terminal 102c so that the output control circuit 108 operates. If the control terminal CW of the output control circuit 108 is to be not coupled to the first control voltage so that the power supply unit 100 generates an output voltage Vout of 12V, the control terminal CW can be floated, grounded or coupled to a suitable voltage level such as the second control voltage less than the first control voltage, so that the output control circuit 108 does not operate.

A first terminal of the first feedback circuit 110 is coupled to the first output terminal 102c to receive the first voltage detection signal V1a, a second terminal of the first feedback circuit 110 is coupled to the first voltage across resistance Ra of the current detection circuit 104 to receive the first current detection signal V1b, and the first feedback circuit 110 is further coupled to the output control circuit 108. The first feedback circuit 110 correspondingly generates the first control signal CS1 based on the first voltage detection signal V1a and the first current detection signal V1b and based on the operating state of the first feedback circuit 110.

In the present embodiment, the power supply unit 100 further includes the second capacitor C2 to provide a function of stabilizing the output voltage Vout. Both ends of the second capacitor C2 are coupled to the anode LED (+) and the cathode LED (−) of the LED 200, respectively.

The coupling circuit 111 is coupled to the first feedback circuit 110 to receive the first control signal CS1, and configured to generate the power conversion control signal CS based on the first control signal CS1.

The power conversion control circuit 112 receives the power conversion control signal CS generated by the first feedback circuit 110 to generate the conversion signal Sc based on the power conversion control signal CS.

As shown in FIG. 1, the power conversion circuit 102 is coupled to the power conversion control circuit 112, and converts the input voltage Vin to the output voltage Vout at an appropriate voltage level based on the conversion signal Sc generated by the power conversion control circuit 112.

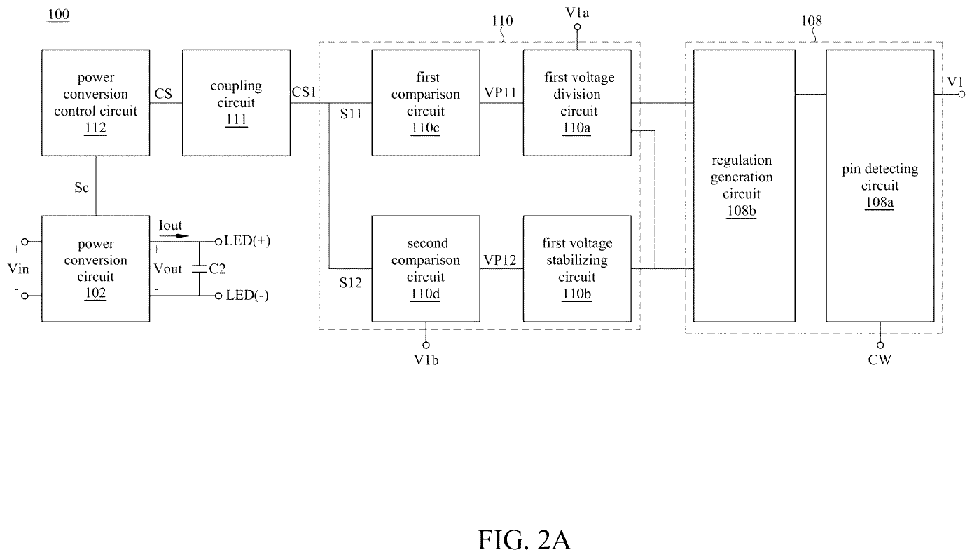

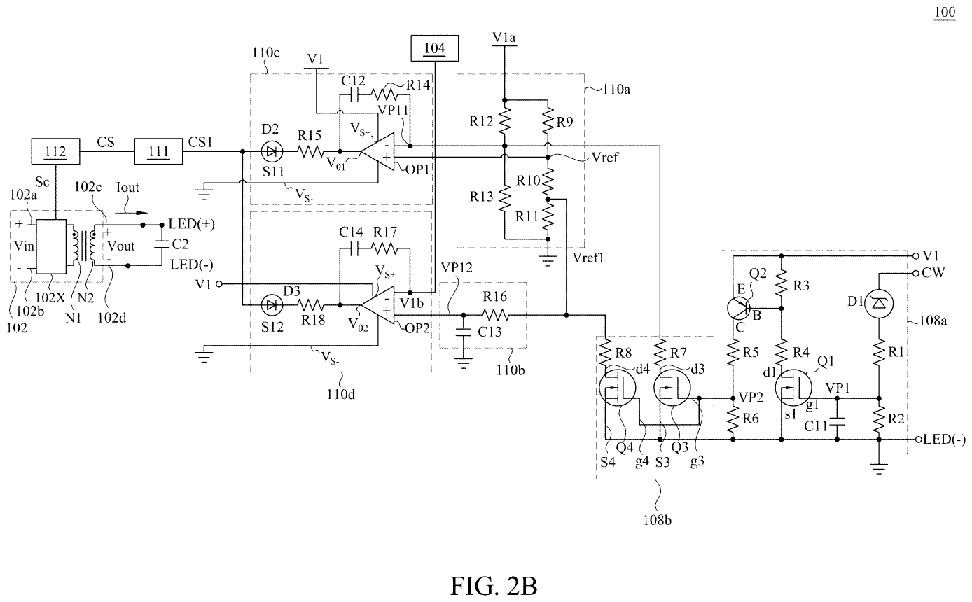

Reference is made to FIG. 2A which is a block diagram showing some circuits of the power supply unit 100 in FIG. 1. For illustrative purposes, FIG. 2A shows only the power conversion circuit 102, the output control circuit 108, the first feedback circuit 110, and the power conversion control circuit 112.

As shown in the embodiment of FIG. 2A, the output control circuit 108 includes the control terminal CW, a pin detecting circuit 108a and a regulation generation circuit 108b. The pin detecting circuit 108a correspondingly sets the operating state of the regulation generation circuit 108b based on the voltage of the control terminal CW. When the control terminal CW is coupled to the first control voltage (e.g., high voltage), the pin detecting circuit 108a sets the regulation generation circuit 108b to operate; and when the control terminal CW is not coupled to the first control voltage (e.g., floated, grounded or coupled to a suitable voltage level such as the second control voltage less than the first control voltage), the pin detecting circuit 108a sets the regulation generation circuit 108b to not operate.

As shown in the embodiment of FIG. 2A, the first feedback circuit 110 includes a first voltage division circuit 110a, a first voltage stabilizing circuit 110b, a first comparison circuit 110c and a second comparison circuit 110d. The first voltage division circuit 110a and the first comparison circuit 110c provide a voltage feedback control function, while the first voltage stabilizing circuit 110b and the second comparison circuit 110d provide a current feedback control function. The first voltage division circuit 110a is coupled to the first output terminal 102c to receive the first voltage detection signal V1a, and the first voltage division circuit 110a is coupled to the regulation generation circuit 108b. When the regulation generation circuit 108b does not operate, the first voltage division circuit 110a generates a first voltage division control signal VP11 having a first level based on the first voltage detection signal V1a; and when the regulation generation circuit 108b operates, the first voltage division circuit 110a generates the first voltage division control signal VP11 having a second level based on the first voltage detection signal V1a. In one embodiment, the first voltage division control signal VP11 having the first level corresponds to the output voltage Vout (12V) of the power conversion circuit 102, and the first voltage division control signal VP11 having the second level corresponds to the output voltage Vout (24V) of the power conversion circuit 102.

In one embodiment, the power supply unit 100 can be set to provide two power specifications, i.e., an output voltage of 12V and a maximum output current of 5 A (maximum output power of 60 W) and an output voltage of 24V and a maximum output current of 2.5 A (maximum output power of 60 W). The first voltage stabilizing circuit 110b is coupled to the regulation generation circuit 108b. When the regulation generation circuit 108b does not operate, a first current division control signal VP12 having a third level generated by the first voltage stabilizing circuit 110b corresponds to the maximum output current Iout of the power conversion circuit 102, which is 5 A. When the regulation generation circuit 108b operates, the first current division control signal VP12 having a fourth level generated by the first voltage stabilizing circuit 110b corresponds to the maximum output current Iout of the power conversion circuit 102, which is 2.5 A.

The first comparison circuit 110c is coupled to the first voltage division circuit 110a, and configured to compare the first voltage division control signal VP11 with a reference voltage signal Vref to generate a first voltage control signal S11 having a fifth or sixth level respectively. In one embodiment, the first voltage control signal S11 having the fifth level corresponds to the output voltage Vout of the power conversion circuit 102, which is 12V, and the first voltage control signal S11 having the sixth level corresponds to the output voltage Vout of the power conversion circuit 102, which is 24V.

The second comparison circuit 110d is coupled to the first voltage stabilizing circuit 110b, and configured to compare the first current division control signal VP12 with the first current detection signal V1b to generate a first current control signal S12 having a seventh or eighth level, respectively. In one embodiment, the first current control signal S12 having the seventh level corresponds to the maximum output current Iout of the power conversion circuit 102, which is 5 A, and the first current control signal S12 having the eighth level corresponds to the maximum output current Iout of the power conversion circuit 102, which is 2.5 A. In the present embodiment, the first control signal CS1 consists of the first voltage control signal S11 and the first current control signal S12.

The first level to the eighth level can be set to the same or different signal levels respectively.

The coupling circuit 111 is coupled to the first comparison circuit 110c and the second comparison circuit 110d, and correspondingly generates the power conversion control signal CS based on the first control signal CS1.

Reference is made to FIG. 2B which is a specific circuit architecture diagram of the power supply unit 100 in FIG. 2A. As shown in the embodiment of FIG. 2B, the pin detecting circuit 108a includes a first switch Q1, a second switch Q2, a first diode D1, a third capacitor C11, a first resistor R1, a second resistor R2, a third resistor R3, a fourth resistor R4, a fifth resistor R5, and a sixth resistor R6. The regulation generation circuit 108b includes a third switch Q3, a fourth switch Q4, a seventh resistor R7, and an eighth resistor R8. In one embodiment, the first switch Q1, the third switch Q3 and the fourth switch Q4 may each be an N-channel MOSFET, the second switch Q2 may be a PNP bipolar junction transistor (BJT), and the first diode D1 may be a Zener diode.

The first diode D1, the first resistor R1, the second resistor R2 and the third capacitor C11 are configured to convert the voltage of the control terminal CW to a suitable voltage level, so that the first switch Q1 and the second switch Q2 are in an on or off state. A cathode LED (−) of the first diode D1 is coupled to the control terminal CW. A first terminal of the first resistor R1 is coupled to an anode LED (+) of the first diode D1. A first terminal of the second resistor R2 is coupled to a second terminal of the first resistor R1, and a second terminal of the second resistor R2 is grounded. A first terminal of the third capacitor C11 is coupled to the second terminal of the first resistor R1, the first terminal of the second resistor R2 and a gate g1 of the first switch Q1, and a second terminal of the third capacitor C11 is grounded. A source s1 of the first switch Q1 is grounded. A first terminal of the third resistor R3 is coupled to the first output terminal 102c of the power conversion circuit 102 to receive the first voltage V1. A first terminal of the fourth resistor R4 is coupled to a second terminal of the third resistor R3, and a second terminal of the fourth resistor R4 is coupled to a drain d1 of the first switch Q1. A base B of the second switch Q2 is coupled to the second terminal of the third resistor R3 and the first terminal of the fourth resistor R4, and an emitter E of the second switch Q2 is coupled to the first output terminal 102c of the power conversion circuit 102 to receive the first voltage V1. A first terminal of the fifth resistor R5 is coupled to a collector C of the second switch Q2. A first terminal of the sixth resistor R6 is coupled to a second terminal of the fifth resistor R5, and a second terminal of the sixth resistor R6 is grounded.

A gate g3 of the third switch Q3 is coupled to the second terminal of the fifth resistor R5 and the first terminal of the sixth resistor R6, and a source s3 of the third switch Q3 is grounded. A first terminal of the seventh resistor R7 is coupled to the first feedback circuit 110, and a second terminal of the seventh resistor R7 is coupled to a drain d3 of the third switch Q3. A gate g4 of the fourth switch Q4 is coupled to the gate g3 of the third switch Q3, the second terminal of the fifth resistor R5 and the first terminal of the sixth resistor R6, and a source s4 of the fourth switch Q4 is coupled to ground. A first terminal of the eighth resistor R8 is coupled to the first feedback circuit 110, and a second terminal of the eighth resistor R8 is coupled to a drain d4 of the fourth switch Q4.

When the control terminal CW is coupled to the first control voltage, the first switch Q1 and the second switch Q2 of the pin detecting circuit 108a are switched on, so that the third switch Q3 and the fourth switch Q4 of the regulation generation circuit 108b are switched on. When the control terminal CW is not coupled to the first control voltage (e.g., floated, grounded or coupled to a suitable voltage level such as the second control voltage less than the first control voltage), the first switch Q1 and the second switch Q2 of the pin detecting circuit 108a are not switched on, so that the third switch Q3 and the fourth switch Q4 of the regulation generation circuit 108b are not switched on.

As shown in the embodiment of FIG. 2B, the first voltage division circuit 110a includes a ninth resistor R9, a tenth resistor R10, an eleventh resistor R11, a twelfth resistor R12, and a thirteenth resistor R13. The first voltage stabilizing circuit 110b includes a fifth capacitor C13 and a sixteenth resistor R16. The first comparison circuit 110c includes a second diode D2, a fourteenth resistor R14, a fifteenth resistor R15, a fourth capacitor C12, and a first operational amplifier OP1. The second comparison circuit 110d includes a third diode D3, a seventeenth resistor R17, an eighteenth resistor R18, a sixth capacitor C14, and a second operational amplifier OP2. The coupling circuit 111 may transmit the first control signal CS1 of the first feedback circuit 110 to the power conversion control circuit 112 in an appropriate signal transmission mode, e.g., an electrical signal, an optical signal, a magnetic signal, or the like. In one embodiment, the coupling circuit 111 includes a photodiode and a photodetector, the photodiode is coupled to the first comparison circuit 110c and the second comparison circuit 110d to convert the first control signal CS1 to an optical signal, and the photodetector receives the optical signal and converts the optical signal to the power conversion control signal CS for transmission to the power conversion control circuit 112.

A first terminal of the ninth resistor R9 receives the first voltage detection signal V1a. A first terminal of the tenth resistor R10 is coupled to a second terminal of the ninth resistor R9 to receive the reference voltage signal Vref. A first terminal of the eleventh resistor R11 is coupled to a second terminal of the tenth resistor R10, and a second terminal of the eleventh resistor R11 is grounded. A first terminal of the twelfth resistor R12 receives the first voltage detection signal V1a. A first terminal of the thirteenth resistor R13 is coupled to a second terminal of the twelfth resistor R12, and a second terminal of the thirteenth resistor R13 is grounded. A non-inverting input terminal (+) of the first operational amplifier OP1 is coupled to the second terminal of the ninth resistor R9 and the first terminal of the tenth resistor R10 to receive the reference voltage signal Vref, and an inverting input terminal (−) of the first operational amplifier OP1 is coupled to the second terminal of the twelfth resistor R12 and the first terminal of the thirteenth resistor R13, a positive power terminal Vs+ of the first operational amplifier OP1 is coupled to the first output terminal 102c of the power conversion circuit 102, and a negative power terminal Vs− of the first operational amplifier OP1 is grounded. A first terminal of the fourteenth resistor R14 is coupled to the inverting input (−) of the first operational amplifier OP1. A first terminal of the fourth capacitor C12 is coupled to a second terminal of the fourteenth resistor R14, and a second terminal of the fourth capacitor C12 is coupled to a first amplification output terminal Vo1 of the first operational amplifier OP1. A first terminal of the fifteenth resistor R15 is coupled to the second terminal of the fourth capacitor C12 and the first amplification output terminal Vo1 of the first operational amplifier OP1. A first terminal of the second diode D2 is coupled to a second terminal of the fifteenth resistor R15. A first terminal of the sixteenth resistor R16 is coupled to the second terminal of the tenth resistor R10 and the first terminal of the eleventh resistor R11. A first terminal of the fifth capacitor C13 is coupled to a second terminal of the sixteenth resistor R16, and a second terminal of the fifth capacitor C13 is grounded. An non-inverting input terminal (+) of the second operational amplifier OP2 is coupled to the second terminal of the sixteenth resistor R16 and the first terminal of the fifth capacitor C13, an inverting input terminal (−) of the second operational amplifier OP2 receives the first current detection signal V1b, a positive power terminal Vs+ of the second operational amplifier OP2 is coupled to the first output terminal 102c of the power conversion circuit 102, and a negative power terminal Vs− of the second operational amplifier OP2 is grounded. A first terminal of the seventeenth resistor R17 is coupled to the inverting input terminal (−) of the second operational amplifier OP2. A first terminal of the sixth capacitor C14 is coupled to a second terminal of the seventeenth resistor R17, and a second terminal of the sixth capacitor C14 is coupled to a second amplification output terminal Vo2 of the second operational amplifier OP2. A first terminal of the eighteenth resistor R18 is coupled to the second terminal of the sixth capacitor C14 and the second amplification output terminal Vo2 of the second operational amplifier OP2. A first terminal of the third diode D3 is coupled to a second terminal of the eighteenth resistor R18, and a second terminal of the third diode D3 is coupled to a second terminal of the second diode D2.

In one embodiment, the reference voltage signal Vref may be a reference voltage signal generated by a constant-voltage voltage source, e.g., a voltage of 2.5V. The reference voltage signal Vref generates a first reference voltage division signal Vref1 through the voltage division of the tenth resistor R10 and the eleventh resistor R11, and the voltage of the first reference voltage division signal Vref1 is

$$\frac{V ref * R 11}{R 10 + R 11} .$$

A first terminal of the power conversion control circuit 112 is coupled to the coupling circuit 111 to receive the power conversion control signal CS and generates the conversion signal Sc based on the power conversion control signal CS to control the power conversion circuit 102 to generate the desired output voltage Vout.

As shown in the embodiment of FIG. 2B, the power conversion circuit 102 includes a SMPS converter 102X, a first winding N1, and a second winding N2. In one embodiment, the first winding N1 is a primary side winding or a primary coil, and the second winding N2 is a secondary side winding or a secondary coil.

First and second terminals of the SMPS converter 102X (i.e., first input terminal 102a and second input terminal 102b) receive the input voltage Vin. Third and fourth terminals of the SMPS converter 102X are coupled to first and second terminals of the first winding N1. A first terminal (i.e., first output terminal 102c) of the second winding N2 is configured to be coupled to the anode LED (+) of the LED 200. A second terminal (i.e., second output terminal 102d) of the second winding N2 is configured to be coupled to the cathode LED (−) of the LED 200.

Therefore, when the control terminal CW is not coupled to the first control voltage (e.g., high voltage), the pin detecting circuit 108a and the regulation generation circuit 108b do not operate, the first comparison circuit 110c correspondingly generates the first voltage control signal S11 based on the first voltage division control signal VP11 and the reference voltage signal Vref, and the second comparison circuit 110d compares the first current division control signal VP12 with the first current detection signal V1b to correspondingly generate the first current control signal S12. The first control signal CS1 includes the first voltage control signal S11 and the first current control signal S12 which are used as feedback signals of voltage feedback control and current feedback control, respectively. The coupling circuit 111 generates the power conversion control signal CS to the power conversion control circuit 112 based on the first control signal CS1, and the power conversion control circuit 112 generates the conversion signal Sc to the power conversion circuit 102 based on the power conversion control signal CS, so that the power conversion circuit 102 generates an output voltage Vout of 12V based on the conversion signal Sc, and controls the maximum output current Iout to be 5 A.

As shown in the embodiment of FIG. 2B, when the control terminal CW is not coupled to the first control voltage (e.g., high voltage), the first diode D1, the first switch Q1 and the second switch Q2 of the pin detecting circuit 108a are not switched on, so that the pin detecting circuit 108a does not operate and correspondingly controls the third switch Q3 and the fourth switch Q4 of the regulation generation circuit 108b to not be switched on. The first voltage detection signal V1a generates, at the inverting input terminal (−) of the first operational amplifier OP1, the first voltage division control signal VP11

$$( i . e . , partial voltage \frac{V 1 a * R 13}{R 12 + R 13} )$$

corresponding to the output voltage Vout of 12V through the voltage division of the twelfth resistor R12 and the thirteenth resistor R13, the first operational amplifier OP1 compares the first voltage division control signal VP11 with the reference voltage signal Vref to generate the first voltage control signal S11 corresponding to the output voltage Vout of 12V, and the sixteenth resistor R16 receives the first reference voltage division signal Vref1 to generate the first current division control signal VP12, and the second operational amplifier OP2 compares the first current division control signal VP12 with the first current detection signal V1b to generate the first current control signal S12.

When the control terminal CW is coupled to the first control voltage (e.g., high voltage), the first control voltage is greater than a breakdown voltage of the first diode D1 so that the first diode D1 is switched on, a voltage obtained by subtracting the breakdown voltage of the first diode D1 from the first control voltage is formed into a first partial voltage VP1 through the voltage division of the first resistor R1 and the second resistor R2, the first partial voltage VP1 is greater than a threshold voltage of the first switch Q1 so that the first switch Q1 and the second switch Q2 are switched on and then the pin detecting circuit 108a operates. By the operation of the pin detecting circuit 108a, the first voltage V1, after subtracting a voltage drop of the second switch Q2, is formed into a second partial voltage VP2 through the voltage division of the fifth resistor R5 and the sixth resistor R6, and the second partial voltage VP2 is greater than a threshold voltage of the third switch Q3 and the fourth switch Q4 so that the third switch Q3 and the fourth switch Q4 can be switched on, and then the regulation generation circuit 108b operates. After the third switch Q3 is switched on, the seventh resistor R7 is connected in parallel to the thirteenth resistor R13, and a resistance value of the seventh resistor R7 connected in parallel to the thirteenth resistor R13 decreases, resulting in a voltage drop at the inverting input terminal (−) of the first operational amplifier OP1. Since a voltage at the non-inverting input terminal (+) of the first operational amplifier OP1 is still the reference voltage signal Vref, the first voltage control signal S11 generated by the first operational amplifier OP1, the first control signal CS1, the power conversion control signal CS generated by the coupling circuit 111 based on the first control signal CS1, and the conversion signal Sc generated by the power conversion control circuit 112 based on the power conversion control signal CS will cause the power conversion circuit 102 to correspondingly raise the output voltage Vout based on the conversion signal Sc, so that the first voltage detection signal V1a rises to that the first voltage division control signal VP11

$$( i . e . , partial voltage \frac{V 1 a * R 13 // R 7}{R 12 + R 13 // R 7} )$$

is equal to reference voltage signal Vref. In the present embodiment, the output voltage Vout at this time is 24V. Similarly, after the fourth switch Q4 is switched on, the eighth resistor R8 is connected in parallel to the eleventh resistor R11, and a resistance value of the eighth resistor R8 connected in parallel to the eleventh resistor R11 decreases, resulting in a voltage drop at the non-inverting input terminal (+) of the second operational amplifier OP2. The first current control signal S12 generated by the second operational amplifier OP2, the first control signal CS1, the power conversion control signal CS generated by the coupling circuit 111 based on the first control signal CS1, and the conversion signal Sc generated by the power conversion control circuit 112 based on the power conversion control signal CS will cause the power conversion circuit 102 to correspondingly reduce the output current Iout based on the conversion signal Sc, so that the first current detection signal V1b decreases to be equal to the first current division control signal VP12. In the present embodiment, the maximum output current Iout at this time is 2.5 A.

As shown in the embodiment of FIG. 2B, when the control terminal CW is coupled to the first control voltage, the first diode D1 is switched on, and the first voltage V1, after subtracting a voltage across the first diode D1, is applied at the gate g1 of the first switch Q1 through the voltage division of the first resistor R1 and the second resistor R2 to generate the first partial voltage VP1 to switch on the first switch Q1.

When the first partial voltage VP1 is greater than the threshold voltage of the first switch Q1 (e.g., 3.5V), the first switch Q1 is switched on, and the first voltage V1 is applied at the base B of the second switch Q2 through the voltage division of the third resistor R3 and the fourth resistor R4, so that the second switch Q2 is switched on, and then the first voltage V1 is transmitted to the collector C of the second switch Q2 (since the voltage drop of the second switch Q2 is much less than the first voltage V1, and is thus negligible). The first voltage V1 of the collector C of the second switch Q2 is applied at the gate g3 of the third switch Q3 and the gate g4 of the fourth switch Q4 through the voltage division of the fifth resistor R5 and the sixth resistor R6 to generate the second partial voltage VP2 (i.e., detection signal). In one embodiment, the second partial voltage VP2 is approximately

$$\frac{V 1 * R 6}{R 5 + R 6} .$$

When the second partial voltage VP2 is greater than the threshold voltage of the third switch Q3 and the fourth switch Q4 (e.g., 3.5V), the third switch Q3 and the fourth switch Q4 are switched on. After the third switch Q3 is switched on, the seventh resistor R7 is connected in parallel to the thirteenth resistor R13 to set the voltage level of the inverting input terminal (−) of the first operational amplifier OP1, the first voltage detection signal V1a is generated at the inverting input terminal (−) of the first operational amplifier OP1 through the voltage division of the twelfth resistor R12, the seventh resistor R7 and the thirteenth resistor R13 to generate the first voltage division control signal VP11 corresponding to the output voltage Vout of 24V, and the first operational amplifier OP1 compares the first voltage division control signal VP11 with the reference voltage signal Vref to generate the first voltage control signal S11 corresponding to the output voltage Vout of 24V. After the fourth switch Q4 is switched on, the eighth resistor R8 is coupled in parallel to the eleventh resistor R11 to set the voltage level of the non-inverting input terminal (+) of the second operational amplifier OP2, the reference voltage signal Vref generates, at the non-inverting input terminal (+) of the second operational amplifier OP2, the first current division control signal VP12 corresponding to the maximum output current Iout of 2.5 A through the voltage division of the tenth resistor R10, the eighth resistor R8 and the eleventh resistor R11, the second operational amplifier OP2 compares the first current division control signal VP12 with the first current detection signal V1b to generate the first current control signal S12 corresponding to the maximum output current Iout of 2.5 A, the first voltage control signal S11 and the first current control signal S12 form the first control signal CS1 corresponding to an output voltage Vout of 24V and a maximum output current Iout of 2.5 A to the coupling circuit 111, the coupling circuit 111 generates the power conversion control signal CS corresponding to an output voltage Vout of 24V and a maximum output current Iout of 2.5 A to the power conversion control circuit 112 based on the first control signal CS1, and the power conversion control circuit 112 generates the conversion signal Sc corresponding to an output voltage Vout of 24V and a maximum output current Iout of 2.5 A to the power conversion circuit 102 based on the power conversion control signal CS, so that the power conversion circuit 102 generates the output voltage Vout of 24V from the input voltage Vin based on the conversion signal Sc and controls the maximum output current Iout to be 2.5 A.

As a result, through the output control circuit 108 and a single-loop control circuit (i.e., first feedback circuit 110) of the power supply unit 100 in FIGS. 1 and 2A-2B, the control terminal CW can be selectively coupled to the first control voltage (e.g., high voltage) to control the output voltage Vout of the power supply unit 100 to be 12V or 24V, so that the power supply unit 100 can achieve the required power output specification of 12V or 24V based on the setting.

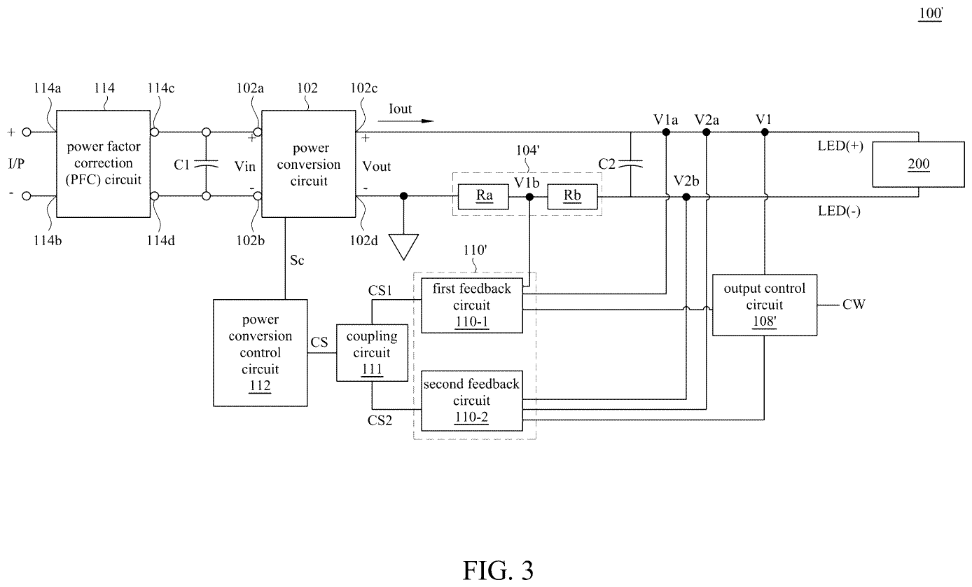

FIG. 3 is a block diagram of another embodiment of a power supply unit according to the present disclosure. Referring to FIG. 1 and FIG. 3, the power supply unit 100 in FIG. 1 and a power supply unit 100′ in FIG. 3 have a partially similar circuit structure, both of which are configured to supply power to the LED 200 and have the power conversion circuit 102, the power conversion control circuit 112, the PFC circuit 114, the first capacitor C1, and the second capacitor C2. The technical disclosure related to FIG. 1 are not repeated.

In the following embodiment, through the control of a signal level of a control terminal CW of an output control circuit 108′, an output voltage Vout of the power supply unit 100′ is controlled to be 12V or 24V, so that the power supply unit 100′ correspondingly supplies power to the LED 200 with a voltage of 12V or the LED 200 with a voltage of 24V. In other embodiments, the output voltage Vout of the power supply unit 100′ may also be set to one of two or more other suitable voltages through the control of the signal level of the control terminal CW of the output control circuit 108′.

In the present embodiment, the power conversion circuit 102 can be set to have both 12V60 W and 24V100 W power output specifications. When the control terminal CW is coupled to a first control voltage (e.g., high voltage), the output control circuit 108′ sets a second feedback circuit 110_2 to operate correspondingly. The output control circuit 108′ and a first feedback circuit 110_1 and the second feedback circuit 110_2 of a feedback circuit 110′ generate and transmit the first control signal CS1 and the second control signal CS2 to the coupling circuit 111 based on the first voltage detection signal V1a, the first current detection signal V1b, the second voltage detection signal V2a and the second current detection signal V2b, the coupling circuit 111 generates and transmits the power conversion control signal CS to the power conversion control circuit 112 based on the first control signal CS1 and the second control signal CS2, and the power conversion control circuit 112 generates and transmits the conversion signal Sc to the power conversion circuit 102 based on the power conversion control signal CS, so that the power conversion circuit 102 performs a power conversion operation on a power input signal (i.e., input voltage Vin) based on the conversion signal Sc to set the output voltage Vout to 24V and control the maximum output current at 4.1 A, so that the maximum output power is set to 100 W.

When the control terminal CW is not coupled to the first control voltage (e.g., grounded or floated), the output control circuit 108′ sets the second feedback circuit 110_2 to correspondingly not operate. The output control circuit 108′ and the first feedback circuit 110_1 of the feedback circuit 110′ generate and transmit the first control signal CS1 to the coupling circuit 111 based on the first voltage detection signal V1a and the first current detection signal V1b, the coupling circuit 111 generates and transmits the power conversion control signal CS to the power conversion control circuit 112 based on the first control signal CS1, and the power conversion control circuit 112 generates and transmits the conversion signal Sc to the power conversion circuit 102 based on the power conversion control signal CS, so that the power conversion circuit 102 performs a power conversion operation on the input voltage Vin based on the conversion signal Sc to set the output voltage Vout to 12V and control the maximum output current at 5A, so that the maximum output power is set to 60 W.

As shown in FIG. 3, the power supply unit 100′ includes a current detection circuit 104′.

The current detection circuit 104′ includes a first voltage across resistor Ra and a second voltage across resistor Rb, a first terminal of the second voltage across resistor Rb is coupled to a second terminal of the first voltage across resistor Ra, and a second terminal of the second voltage across resistor Rb is coupled to the cathode LED (−) of the LED 200, and coupled to the first output terminal 102c and the anode LED (+) of the LED 200 through the second capacitor C2. Since the voltages of the first voltage across resistor Ra and the second voltage across resistor Rb are positively correlated with the currents flowing through the first voltage across resistor Ra and the second voltage across resistor Rb respectively, the voltage values of the first voltage across resistor Ra and the second voltage across resistor Rb can be taken as the first current detection signal V1b and the second current detection signal V2b, respectively, to detect a value of a current flowing through the current detection circuit 104′.

As shown in FIG. 3, the power supply unit 100′ includes an output control circuit 108′ coupled to the first output terminal 102c and a feedback circuit 110′.

As shown in FIG. 3, the power supply unit 100′ includes the feedback circuit 110′ including the first feedback circuit 110_1 and the second feedback circuit 110_2. In one embodiment, the first feedback circuit 110_1 has a circuit structure similar to that of the first feedback circuit 110 in FIG. 1, so the technical disclosure of the first feedback circuit 110_1 related to FIG. 1 is not detailed.

As shown in the embodiment of FIG. 3, a first terminal of the second feedback circuit 110_2 is coupled to the first output terminal 102c to receive the second voltage detection signal V2a, and a second terminal of the second feedback circuit 110_2 is coupled to a current detection circuit 104′ and the cathode LED (−) of the LED 200 to receive the second current detection signal V2b. The second feedback circuit 110_2 is further coupled to the output control circuit 108′ to selectively receive the first voltage V1. The second feedback circuit 110_2 correspondingly generates the second control signal CS2 based on the second voltage detection signal V2a and the second current detection signal V2b and based on the setting of the output control circuit 108′ (i.e., whether the first voltage V1 is received). In one embodiment, the second feedback circuit 110_2 has a circuit structure similar to those of the first feedback circuit 110 in FIG. 1 and the first feedback circuit 110_1, the second voltage detection signal V2a is equal to or close to the voltage value of the first voltage V1, and the second current detection signal V2b is a voltage value at the second voltage across resistor Rb.

The coupling circuit 111 is coupled to the first feedback circuit 110_1 and the second feedback circuit 110_2 to receive the first control signal CS1 and the second control signal CS2, and configured to generate the power conversion control signal CS based on the first control signal CS1 and the second control signal CS2.

The power conversion control circuit 112 is coupled to the coupling circuit 111 and configured to generate the conversion signal Sc based on the power conversion control signal CS. The power conversion circuit 102 is coupled to the power conversion control circuit 112, and converts the input voltage Vin to the output voltage Vout having an appropriate voltage level based on the conversion signal Sc generated by the power conversion control circuit 112.

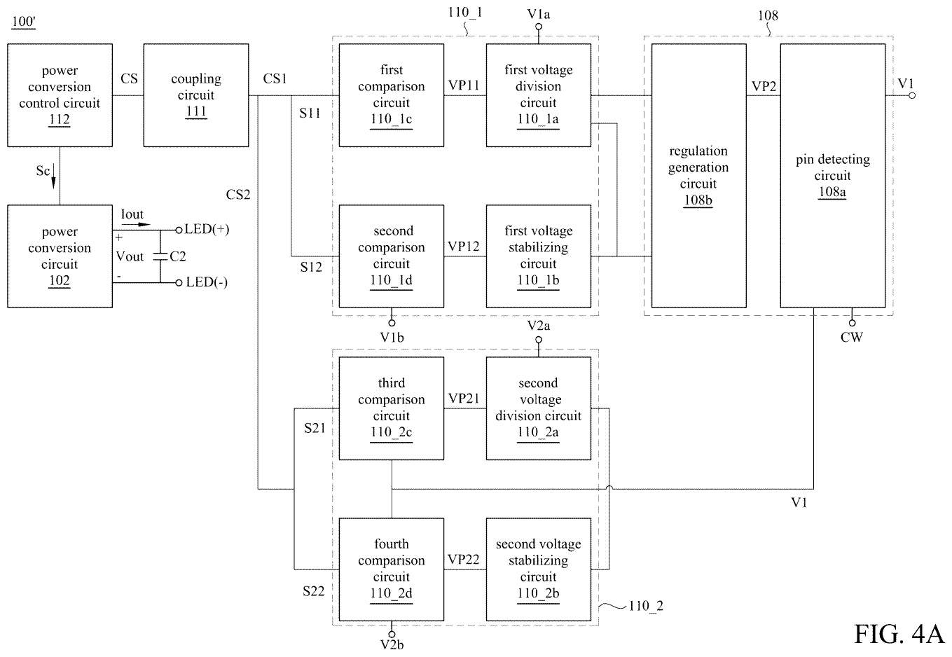

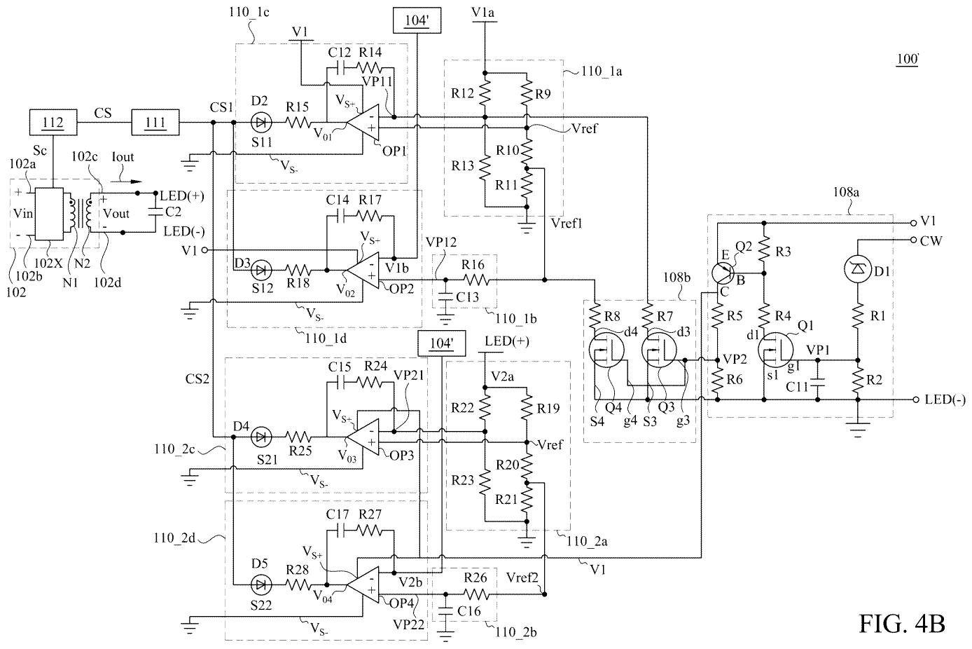

FIG. 4A is a block diagram showing some circuits of the power supply unit 100′ in FIG. 3. For illustrative purposes, FIG. 4A shows only the power conversion circuit 102, the output control circuit 108′, the first feedback circuit 110_1, the second feedback circuit 110_2, the coupling circuit 111, and the power conversion control circuit 112. Referring to FIGS. 2A and 4A, since the power conversion circuit 102 and the power conversion control circuit 112 in FIGS. 2A and 4A, the output control circuit 108 in FIG. 2A and the output control circuit 108′ in FIG. 4A, the first feedback circuit 110 in FIG. 2A (including the first voltage division circuit 110a, the first voltage stabilizing circuit 110b, the first comparison circuit 110c and the second comparison circuit 110d), and the first feedback circuit 110_1 in FIG. 4A (including a first voltage division circuit 110_1a, a first voltage stabilizing circuit 110_1b, a first comparison circuit 110_1c and a second comparison circuit 110_1d) have the same or similar circuit structures, the technical disclosures related to FIG. 2A will not be repeated.

As shown in FIG. 4A, when the control terminal CW is coupled to the first control voltage (e.g., high voltage), the pin detecting circuit 108a sets the regulation generation circuit 108b to operate, and provides the first voltage V1 to the second feedback circuit 110_2 as the working voltage, so that the second feedback circuit 110_2 receives the first voltage V1 and operates; and when the control terminal CW is not coupled to the first control voltage (e.g., floated, grounded or coupled to a suitable voltage level such as a second control voltage less than the first control voltage), the pin detecting circuit 108a sets the regulation generation circuit 108b to not operate, and does not provide the first voltage V1 to the second feedback circuit 110_2 as the working voltage, so that the second feedback circuit 110_2 does not receive the first voltage V1 and does not operate.

As shown in FIG. 4A, the power supply unit 100′ includes the first feedback circuit 110_1 and the second feedback circuit 110_2. In one embodiment, the second feedback circuit 110_2 has a circuit structure similar to that of the first feedback circuit 110_1. In one embodiment, as shown in FIG. 4A, the second feedback circuit 110_2 includes a second voltage division circuit 110_2a, a second voltage stabilizing circuit 110_2b, a third comparison circuit 110_2c, and a fourth comparison circuit 110_2d. The second voltage division circuit 110_2a and the third comparison circuit 110_2c provide a voltage feedback control function, while the second voltage stabilizing circuit 110_2b and the fourth comparison circuit 110_2d provide a current feedback control function. The second voltage division circuit 110_2a is coupled to the first output terminal 102c to receive the second voltage detection signal V2a, and the second voltage division circuit 110_2a generates a second voltage division control signal VP21 based on the second voltage detection signal V2a. The second voltage stabilizing circuit 110_2b is coupled to the second voltage division circuit 110_2a to receive a partial voltage of the second voltage detection signal V2a, and the partial voltage of the second voltage detection signal V2a is used as a second current division control signal VP22. The third comparison circuit 110_2c is coupled to the second voltage division circuit 110_2a and the pin detecting circuit 108a; when the pin detecting circuit 108a does not provide the first voltage V1 to the third comparison circuit 110_2c, the third comparison circuit 110_2c does not operate; and when the pin detecting circuit 108a provides the first voltage V1 to the third comparison circuit 110_2c, the third comparison circuit 110_2c operates and is configured to generate a second voltage control signal S21 based on the second voltage division control signal VP21. The fourth comparison circuit 110_2d is coupled to the second voltage stabilizing circuit 110_2b and the pin detecting circuit 108a; when the pin detecting circuit 108a does not provide the first voltage V1 to the fourth comparison circuit 110_2d, the fourth comparison circuit 110_2d does not operate; and when the pin detecting circuit 108a provides the first voltage V1 to the fourth comparison circuit 110_2d, the fourth comparison circuit 110_2d operates and is configured to generate a second current control signal S22 based on the second current division control signal VP22 and the second current detection signal V2b. In one embodiment, the second control signal CS2 consists of the second voltage control signal S21 and the second current control signal S22. In one embodiment, the second voltage division control signal VP21 and the second voltage control signal S21 correspond to the output voltage Vout of the power conversion circuit 102, which is 24V, and the second current division control signal VP22 and the second current control signal S22 correspond to the output current Iout of the power conversion circuit 102, which is 4.1 A.

As shown in the embodiment in FIG. 4A, the coupling circuit 111 is coupled to the first comparison circuit 110_1c, the second comparison circuit 110_1d, the third comparison circuit 110_2c and the fourth comparison circuit 110_2d to receive the first control signal CS1 and the second control signal CS2, so as to generate the power conversion control signal CS based on the first control signal CS1 and the second control signal CS2.

Reference is made to FIG. 4B which is a specific circuit architecture diagram of the power supply unit 100′ in FIG. 4A. Referring to FIG. 2B and FIG. 4B, since the pin detecting circuits 108a and the regulation generation circuits 108b in FIG. 2B and FIG. 4B have the same or similar circuit structure, the technical disclosure related to FIG. 2B is not repeated.

Referring to FIG. 2B and FIG. 4B, since the circuit structures of the first voltage division circuit 110_1a, the first voltage stabilizing circuit 110_1b, the first comparison circuit 110_1c and the second comparison circuit 110_1d in FIG. 4B are the same or similar to those of the first voltage division circuit 110a, the first voltage stabilizing circuit 110b, the first comparison circuit 110c and the second comparison circuit 110d in FIG. 2B, the technical disclosures related to FIG. 2B are not repeated.

As shown in the embodiment of FIG. 4B, the second voltage division circuit 110_2a includes a nineteenth resistor R19, a twentieth resistor R20, a twenty-first resistor R21, a twenty-second resistor R22 and a twenty-third resistor R23, the second voltage stabilizing circuit 110_2b includes an eighth capacitor C16 and a twenty-sixth resistor R26, the third comparison circuit 110_2c includes a fourth diode D4, a seventh capacitor C15, a twenty-fourth resistor R22, a twenty-fifth resistor R25 and a third operational amplifier OP3, and the fourth comparison circuit 110_2d includes a fifth diode D5, a ninth capacitor C17, a twenty-seventh resistor R27, a twenty-eighth resistor R28, and a fourth operational amplifier OP4. The coupling circuit 111 may transmit the first control signal CS1 of the first feedback circuit 110_1 and the second control signal CS2 of the second feedback circuit 110_2 to the power conversion control circuit 112 in an appropriate signal transmission mode, e.g., an electrical signal, an optical signal, a magnetic signal, or the like. In one embodiment, the coupling circuit 111 includes a photodiode and a photodetector. The photodiode is coupled to the first comparison circuit 110_1c, the second comparison circuit 110_1d, the third comparison circuit 110_2c and the fourth comparison circuit 110_2d to convert the first control signal CS1 and the second control signal CS2 to an optical signal, and the photodetector receives the optical signal and converts the optical signal to the power conversion control signal CS for transmission to the power conversion control circuit 112.

A first terminal of the nineteenth resistor R19 receives the second voltage detection signal V2a. A first terminal of the twentieth resistor R20 is coupled to a second terminal of the nineteenth resistor R19 to receive the reference voltage signal Vref. A first terminal of the twenty-first resistor R21 is coupled to a second terminal of the twentieth resistor R20, and a second terminal of twenty-first resistor R21 is grounded. A first terminal of the twenty-second resistor R22 receives the second voltage detection signal V2a. A first terminal of the twenty-third resistor R23 is coupled to a second terminal of the twenty-second resistor R22, and a second terminal of the twenty-third resistor R23 is grounded. A non-inverting input terminal (+) of the third operational amplifier OP3 is coupled to the second terminal of the nineteenth resistor R19 and the first terminal of the twentieth resistor R20 to receive the reference voltage signal Vref, and an inverting input terminal (−) of the third operational amplifier OP3 is coupled to the second terminal of the twenty-second resistor R22 and the first terminal of the twenty-third resistor R23, a positive power terminal Vs+ of the third operational amplifier OP3 is coupled to a collector C of the second switch Q2, and a negative power terminal Vs− of the third operational amplifier OP3 is grounded. A first terminal of the twenty-fourth resistor R22 is coupled to the inverting input terminal (−) of the third operational amplifier OP3. A first terminal of the seventh capacitor C15 is coupled to the second terminal of the twenty-fourth resistor R22, and a second terminal of the seventh capacitor C15 is coupled to a third amplification output terminal Vo3 of the third operational amplifier OP3. A first terminal of the twenty-fifth resistor R25 is coupled to the second terminal of the seventh capacitor C15 and the third amplification output terminal Vo3 of the third operational amplifier OP3. A first terminal of the fourth diode D4 is coupled to a second terminal of the twenty-fifth resistor R25. A first terminal of the twenty-sixth resistor R26 is coupled to the second terminal of the twentieth resistor R20 and the first terminal of the twenty-first resistor R21. A first terminal of the eighth capacitor C16 is coupled to a second terminal of the twenty-sixth resistor R26, and a second terminal of the eighth capacitor C16 is grounded. A non-inverting input terminal (+) of the fourth operational amplifier OP4 is coupled to the second terminal of the twenty-sixth resistor R26 and the first terminal of the eighth capacitor C16, an inverting input terminal (−) of the fourth operational amplifier OP4 receives the second current detection signal V2b, a positive power terminal Vs+ of the fourth operational amplifier OP4 is coupled to the positive power terminal Vs+ of the third operational amplifier OP3 and the collector C of the second switch Q2, and a negative power terminal Vs− of the fourth operational amplifier OP4 is grounded. A first terminal of the twenty-seventh resistor R27 is coupled to the inverting input terminal (−) of the fourth operational amplifier OP4. A first terminal of the ninth capacitor C17 is coupled to a second terminal of the twenty-seventh resistor R27, and a second terminal of the ninth capacitor C17 is coupled to a fourth amplification output terminal Vo4 of the fourth operational amplifier OP4. A first terminal of the twenty-eighth resistor R28 is coupled to the second terminal of the ninth capacitor C17 and the fourth amplification output terminal Vo4 of the fourth operational amplifier OP4. A first terminal of the fifth diode D5 is coupled to a second terminal of the twenty-eighth resistor R28, and a second terminal of the fifth diode D5 is coupled to a second terminal of the fourth diode D4.

In one embodiment, the thirteenth resistor R13 is greater than the twenty-third resistor R23, and a resistance value of the twenty-third resistor R23 is substantially equal to that of the seventh resistor R7 connected in parallel to the thirteenth resistor R13. The eleventh resistor R11 is greater than the twenty-first resistor R21, and a resistance value of the twenty-first resistor R21 is essentially equal to that of the eighth resistor R8 connected in parallel to the eleventh resistor R11.

In one embodiment, the reference voltage signal Vref generates a second reference voltage division signal Vref2 through the voltage division of the twentieth resistor R20 and the twenty-first resistor R21, and the voltage of the second reference voltage division signal Vref2 is

$$\frac{V ref * R 21}{R 20 + R 21} ,$$

wherein the second reference voltage division signal Vref2 is substantially equal to the first reference voltage division signal

$$V ref 1 \frac{V ref * R 11 // R 8}{R 10 + R 11 // R 8} .$$

Therefore, when the control terminal CW is not coupled to the first control voltage (e.g., high voltage), the pin detecting circuit 108a, the regulation generation circuit 108b and the second feedback circuit 110_2 do not operate. In the first feedback circuit 110_1, the first voltage detection signal V1a generates, at the inverting input terminal (−) of the first operational amplifier OP1, the first voltage division control signal VP11

$$( i . e . , partial voltage \frac{V 1 a * R 13}{R 12 + R 13} )$$

corresponding to the output voltage Vout of 12V through the voltage division of the twelfth resistor R12 and the thirteenth resistor R13, the first operational amplifier OP1 compares the first voltage division control signal VP11 with the reference voltage signal Vref to generate the first voltage control signal S11 corresponding to the output voltage Vout of 12V, the sixteenth resistor R16 receives the first reference voltage division signal Vref1 to generate the first current division control signal VP12, and the second operational amplifier OP2 compares the first current division control signal VP12 with the first current detection signal V1b to generate the first current control signal S12. As a result, the first comparison circuit 110_1c correspondingly generates the first voltage control signal S11 based on the first voltage division control signal VP11 and the reference voltage signal Vref, and the second comparison circuit 110_1d compares the first current division control signal VP12 with the first current detection signal V1b to correspondingly generate the first current control signal S12. The first control signal CS1 includes the first voltage control signal S11 and the first current control signal S12 which are used as feedback signals of voltage feedback control and current feedback control, respectively. The coupling circuit 111 generates the power conversion control signal CS to the power conversion control circuit 112 based on the first control signal CS1, and the power conversion control circuit 112 generates the conversion signal Sc to the power conversion circuit 102 based on the power conversion control signal CS, so that the power conversion circuit 102 generates an output voltage Vout of 12V based on the conversion signal Sc, and controls the maximum output current Iout to be 5 A.

As shown in the embodiment of FIG. 4B, when the control terminal CW is not coupled to the first control voltage (e.g., high voltage), the first diode D1, the first switch Q1 and the second switch Q2 of the pin detecting circuit 108a are not switched on, so that the pin detecting circuit 108a does not operate to correspondingly control the third switch Q3 and the fourth switch Q4 of the regulation generation circuit 108b to be not switched on, and will not provide the first voltage V1 to the third operational amplifier OP3 and the fourth operational amplifier OP4. The third operational amplifier OP3 and the fourth operational amplifier OP4 do not receive the first voltage V1 so that the third comparison circuit 110_2c and the fourth comparison circuit 110_2d do not operate, respectively. When the control terminal CW of the power supply unit 100′ is not coupled to the first control voltage (e.g., high voltage), the output control circuit 108 will not supply the first voltage V1 to the second feedback circuit 110_2, so that the second feedback circuit 110_2 does not operate.

When the control terminal CW is coupled to the first control voltage (e.g., high voltage), the first control voltage is greater than the breakdown voltage of the first diode D1 so that the first diode D1 is switched on, the voltage obtained by subtracting the breakdown voltage of the first diode D1 from the first control voltage is formed into the first partial voltage VP1 through the voltage division of the first resistor R1 and the second resistor R2, wherein the first partial voltage VP1 is greater than the threshold voltage of the first switch Q1 so that the first switch Q1 and the second switch Q2 are switched on and then the pin detecting circuit 108a operates. By the operation of the pin detecting circuit 108a, the first voltage V1, after subtracting a voltage drop of the second switch Q2, is formed into a second partial voltage VP2 through the voltage division of the fifth resistor R5 and the sixth resistor R6, and the second partial voltage VP2 is greater than the threshold voltage of the third switch Q3 and the fourth switch Q4 so that the third switch Q3 and the fourth switch Q4 can be switched on, and then the regulation generation circuit 108b operates. In addition, by the operation of the pin detecting circuit 108a, the first voltage V1 is transmitted to the third comparison circuit 110_2c and the fourth comparison circuit 110_2d due to the second switch Q2 being switched on, so that the third comparison circuit 110_2c and the fourth comparison circuit 110_2d operate. After the third switch Q3 is switched on, the seventh resistor R7 is connected in parallel to the thirteenth resistor R13, and a resistance value of the seventh resistor R7 connected in parallel to the thirteenth resistor R13 decreases, resulting in a voltage drop at the inverting input terminal (−) of the first operational amplifier OP1. Since the voltages at the non-invert input terminals (+) of the first operational amplifier OP1 and the third operational amplifier OP3 are still the reference voltage signal Vref, the first voltage control signal S11 generated by the first operational amplifier OP1, the second voltage control signal S21 generated by the third operational amplifier OP3, the first control signal CS1, the second control signal CS2, the power conversion control signal CS generated by the coupling circuit 111 based on the first control signal CS1 and the second control signal CS2, and the conversion signal Sc generated by the power conversion control circuit 112 based on the power conversion control signal CS will cause the power conversion circuit 102 to correspondingly raise the output voltage Vout based on the conversion signal Sc, so that the first voltage detection signal V1a rises to that the first voltage division control signal VP11

$$( i . e . , partial voltage \frac{V 1 a * R 13 // R 7}{R 12 + R 13 // R 7} )$$

is equal to the reference voltage signal Vref. In the present embodiment, the output voltage Vout at this time is 24V. Similarly, after the fourth switch Q4 is switched on, the eighth resistor R8 is connected in parallel to the eleventh resistor R11, and a resistance value of the eighth resistor R8 connected in parallel to the eleventh resistor R11 decreases, resulting in a voltage drop at the non-inverting input terminal (+) of the second operational amplifier OP2. The first current control signal S12 generated by the second operational amplifier OP2, the second current control signal S22 generated by the fourth operational amplifier OP4, the first control signal CS1, the second control signal CS2, the power conversion control signal CS generated by the coupling circuit 111 based on the first control signal CS1 and the second control signal CS2, and the conversion signal Sc generated by the power conversion control circuit 112 based on the power conversion control signal CS will cause the power conversion circuit 102 to correspondingly reduce the output current Iout based on the conversion signal Sc, so that the first current detection signal V1b decreases to be equal to the first current division control signal VP12. In the present embodiment, the maximum output current Iout at this time is 4.1 A.

The second voltage detection signal V2a is generated at the inverting input terminal (−) of the third operational amplifier OP3 through the voltage division of the twenty-second resistor R22 and the twenty-third resistor R23 to form the second voltage division control signal VP21 corresponding to an output voltage Vout of 24V, and the third operational amplifier OP3 compares the second voltage division control signal VP21 with the reference voltage signal Vref to generate the second voltage control signal S21 corresponding to an output voltage Vout of 24V. The reference voltage signal Vref generates the second reference voltage partial signal Vref2 to the twenty-sixth resistor R26 through the voltage division of the twentieth resistor R20 and the twenty-first resistor R21, the twenty-sixth resistor R26 generates, based on the second reference voltage division signal Vref2, the second current division control signal VP22 corresponding to a maximum output current Iout of 4.1 A at the non-inverting input terminal (+) of the fourth operational amplifier OP4, the fourth operational amplifier OP4 compares the second current division control signal VP22 with the second current detection signal V2b to generate the second current control signal S22 corresponding to a maximum output current Iout of 4.1 A, the second voltage control signal S21 and the second current control signal S22 form the second control signal CS2 corresponding to an output voltage Vout of 24V and a maximum output current Iout of 4.1 A to the coupling circuit 111, the coupling circuit 111 generates the power conversion control signal CS corresponding to an output voltage Vout of 24V and a maximum output current Iout of 4.1 A to the power conversion control circuit 112 based on the first control signal CS1 and the second control signal CS2, and the power conversion control circuit 112 generates the conversion signal Sc corresponding to an output voltage Vout of 24V and a maximum output current Iout of 4.1 A to the power conversion circuit 102 based on the power conversion control signal CS, so that the power conversion circuit 102 generates the output voltage Vout of 24V from the input voltage Vin based on the conversion signal Sc and controls the maximum output current Iout to be 4.1 A.

Based on a maximum output power of the power supply unit, the power supply unit needs to meet the requirements of corresponding safety specifications. In terms of the above embodiments, when the output power of the power supply unit is 60 W, a single feedback circuit can be used. When the output power of the power supply unit is 100 W, two feedback circuits must be used, and when any one of the two feedback circuits fails, the power supply unit still can operate normally by the single feedback circuit, so the power supply unit can meet safety specifications (e.g., UL 8750 Class 2 safety specification) through the redundant feedback circuit design.

Thus, the power supply units 100, 100′ in the above embodiments, whether using a single feedback circuit or two or more feedback circuits with the redundant design, can achieve different output voltages by selectively coupling the control terminal CW to the first control voltage (e.g., high voltage) to control the output voltage Vout of the power supply unit 100′ to be 12V or 24V, set the output currents correspondingly to provide different output powers, and achieve a constant voltage control function and/or a constant current control function.

In other embodiments, the control terminal CW can also be pre-coupled to the first output terminal 102c of the power conversion circuit 102 or another suitable position. Accordingly, when the power supply unit 100, 100′ is powered on, the control terminal CW is coupled to a first control voltage (e.g., a high voltage), such that the default output voltage Vout of the power supply unit 100, 100′ is a higher voltage value (e.g., 24V in the aforementioned embodiment). To set the default output voltage Vout of the power supply unit 100, 100′ to a lower voltage value (e.g., 12V in the aforementioned embodiment), the connection line between the control terminal CW and the first output terminal 102c of the power conversion circuit 102 can be severed. As a result, when the power supply unit 100, 100′ is powered on, the control terminal CW is not coupled to the first control voltage (e.g., it is left floating, grounded, or coupled to a suitable voltage level such as a second control voltage that is less than the first control voltage), thereby outputting a lower output voltage Vout.

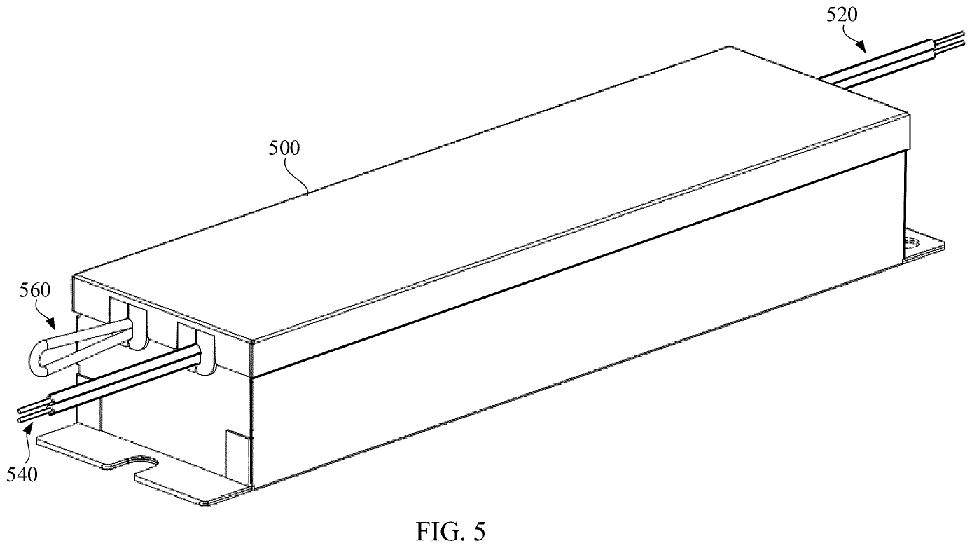

In the embodiment of FIG. 5, the housing 500 is configured to accommodate some or all of the components of the power supply unit 100, 100′. Connection lines 520 and 540 serve as an input connection line and an output connection line, respectively, for coupling to the input and output terminals of the power supply unit 100, 100′. For example, the connection line 520 serves as the input connection line and is coupled to the AC input terminals 114a and 114b of the power factor correction circuit 114 to receive an original voltage I/P, while the connection line 540 serves as the output connection line and is coupled to the output terminals 102c and 102d of the power conversion circuit 102 to be coupled to the light-emitting diode 200. In another embodiment, the connection line 540 serves as the input connection line and is coupled to the AC input terminals 114a and 114b of the power factor correction circuit 114 to receive the original voltage I/P, while the connection line 520 serves as the output connection line and is coupled to the output terminals 102c and 102d of the power conversion circuit 102 to be coupled to the light-emitting diode 200. The output voltage control line 560 is coupled between the control terminal CW and the first output terminal 102c of the power conversion circuit 102 or another suitable position, such that the default output voltage Vout of the power supply unit 100, 100′ is a higher voltage value (e.g., 24V in the aforementioned embodiment). When the output voltage control line 560 is severed, that is, when the output voltage control line 560 is non-conductive, the control terminal CW is not coupled to the first control voltage, and the default output voltage Vout of the power supply unit 100, 100′ is a lower voltage value (e.g., 12V in the aforementioned embodiment).

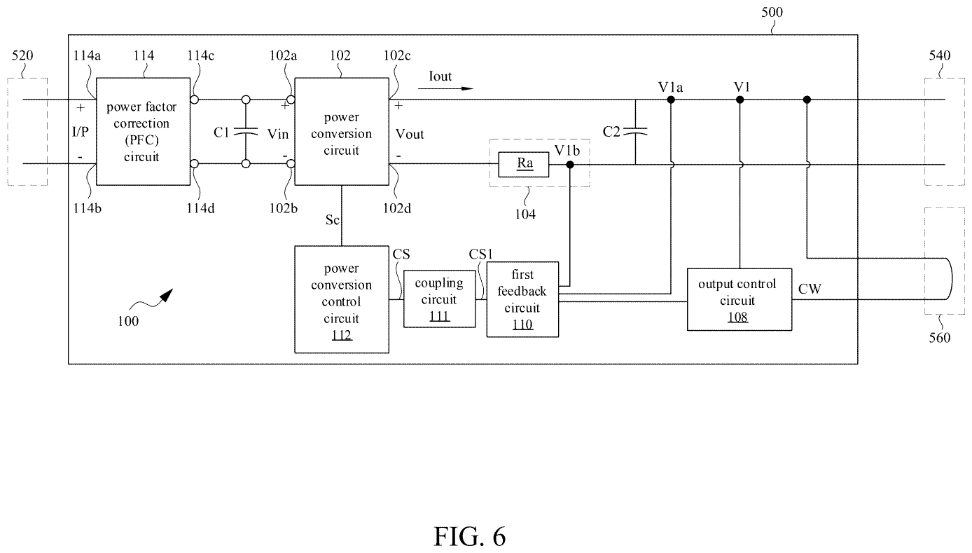

In the embodiment of FIG. 6, the power supply unit 100 of FIG. 1 is installed in the housing 500 of FIG. 5. The connection line 520 is coupled to the AC input terminals 114a and 114b of the power factor correction circuit 114 to receive the original voltage I/P, while the connection line 540 is coupled to the output terminals 102c and 102d of the power conversion circuit 102 to be coupled to the light-emitting diode 200. The output voltage control line 560 is coupled between the control terminal CW and the first output terminal 102c of the power conversion circuit 102. Consequently, the default output voltage Vout of the power supply unit 100 is a higher voltage value (e.g., 24V in the aforementioned embodiment). When the output voltage control line 560 is severed, the control terminal CW is not coupled to the first output terminal 102c, and the default output voltage Vout of the power supply unit 100 is a lower voltage value (e.g., 12V in the aforementioned embodiment).

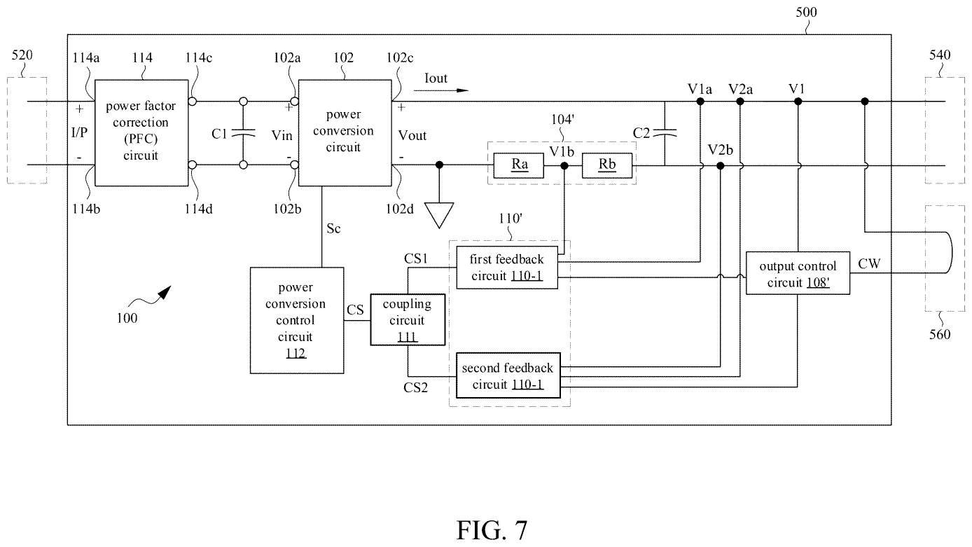

In the embodiment of FIG. 7, the power supply unit 100′ of FIG. 3 is installed in the housing 500 of FIG. 5. The connection line 520 is coupled to the AC input terminals 114a and 114b of the power factor correction circuit 114 to receive the original voltage I/P, while the connection line 540 is coupled to the output terminals 102c and 102d of the power conversion circuit 102 to be coupled to the light-emitting diode 200. The output voltage control line 560 is coupled between the control terminal CW and the first output terminal 102c of the power conversion circuit 102. Consequently, the default output voltage Vout of the power supply unit 100′ is a higher voltage value (e.g., 24V in the aforementioned embodiment). When the output voltage control line 560 is severed, the control terminal CW is not coupled to the first output terminal 102c, and the default output voltage Vout of the power supply unit 100′ is a lower voltage value (e.g., 12V in the aforementioned embodiment).

In the embodiments of FIGS. 5-7, at least a portion of the power supply unit is installed within the housing. The output voltage control line is pre-connected to the output terminal of the power conversion circuit or another suitable position, with at least a portion of the output voltage control line exposed from the housing. By setting the output voltage control line 560 to a conductive state, the power supply unit is configured to provide a higher output voltage; conversely, by setting the output voltage control line 560 to a non-conductive state, the power supply unit is configured to provide a lower output voltage. Therefore, the output voltage of the power supply unit can be configured by setting the conductive state of the output voltage control line 560, which enhances the convenience and stability of installation.

Although the present disclosure has been disclosed as above in embodiments, the embodiments are not intended to limit the present disclosure. Those having ordinary skill in the technical field to which the present disclosure pertains may make various changes and embellishments without departing from the spirit and scope of the present disclosure. Therefore, the scope of protection of the present disclosure shall be defined in the attached claims.

What is claimed is:

1. A power supply unit configured to supply power to a load, the power supply unit comprising:
a power conversion circuit, comprising a first input terminal, a second input terminal, a first output terminal and a second output terminal, the first input terminal and the second input terminal being configured to receive an input voltage, the first output terminal and the second output terminal being configured to be coupled to the load;
an output control circuit, coupled to the first output terminal and having a control terminal;
a current detection circuit, comprising a first terminal coupled to the second output terminal of the power conversion circuit and a second terminal configured to be coupled to the load;
a first feedback circuit, coupled to the first output terminal of the power conversion circuit to receive a first voltage detection signal, coupled to the current detection circuit to receive a first current detection signal, and coupled to the output control circuit to correspondingly generate a first control signal;
a coupling circuit, coupled to the first feedback circuit to receive the first control signal, and configured to generate a power conversion control signal based on the first control signal;
a power conversion control circuit, coupled to the coupling circuit and the power conversion circuit, and configured to generate a conversion signal based on the power conversion control signal; and
a housing, accommodating at least one of the power conversion circuit, the output control circuit, the current detection circuit, the first feedback circuit, the coupling circuit, and the power conversion control circuit; and
an output voltage control line, coupled between the control terminal of the output control circuit and the first output terminal of the power conversion circuit, wherein at least a portion of the output voltage control line is exposed from the housing;
wherein when the output voltage control line is set to be conductive, the control terminal of the output control circuit is coupled to the first output terminal of the power conversion circuit through the output voltage control line to receive a control voltage, the output control circuit sets the first feedback circuit according to the control voltage so as to generate the first control signal, and the first control signal sets the power conversion circuit to correspondingly generate a first output voltage, and the power conversion circuit has a first maximum output current;
when the output voltage control line is set to be non-conductive, the control terminal of the output control circuit is not coupled to the first output terminal of the power conversion circuit, the output control circuit sets the first feedback circuit to generate the first control signal and the first control signal sets the power conversion circuit to correspondingly generate a second output voltage, and the power conversion circuit has a second maximum output current; and
the first output voltage is greater than the second output voltage, and the first maximum output current is less than the second maximum output current.

2. The power supply unit according to claim 1, wherein the output control circuit further comprises:
a pin detecting circuit, coupled to the first output terminal and the control terminal; and
a regulation generation circuit, coupled to the pin detecting circuit and the first feedback circuit;
the first feedback circuit further comprises:
a first voltage division circuit, coupled to the first output terminal to receive the first voltage detection signal, coupled to a reference voltage signal and the regulation generation circuit, and configured to generate a first voltage division control signal;
a first voltage stabilizing circuit, coupled to the first voltage division circuit and the regulation generation circuit, and configured to generate a first current division control signal based on the reference voltage signal;
a first comparison circuit, coupled to the first voltage division circuit, and configured to compare the first voltage division control signal with the reference voltage signal to generate a first voltage control signal; and
a second comparison circuit, coupled to the first voltage stabilizing circuit, and configured to compare the first current division control signal with the first current detection signal to generate a first current control signal;
wherein the coupling circuit is coupled to the first comparison circuit and the second comparison circuit, and correspondingly generates the power conversion control signal based on the first voltage control signal and the first current control signal;
when the output voltage control line is set to be non-conductive, the pin detecting circuit and the regulation generation circuit do not operate, so that the first voltage division circuit performs voltage division on the first voltage detection signal to generate the first voltage division control signal having a first level, and the first voltage stabilizing circuit generates a first current division control signal having a third level based on a first reference voltage division signal generated by voltage division of the reference voltage signal, so that the power conversion circuit correspondingly generates the second output voltage and has the second maximum output current; and
when the output voltage control line is set to be conductive, the control terminal is coupled to the control voltage, the pin detecting circuit sets the regulation generation circuit to operate to change one or more resistance values of the regulation generation circuit coupled to the first feedback circuit, so that the first voltage division circuit performs voltage division on the first voltage detection signal to generate the first voltage division control signal having a second level, and the first voltage stabilizing circuit generates the first current division control signal having a fourth level based on the first reference voltage division signal, so that the power conversion circuit correspondingly generates the first output voltage and has the first maximum output current.

3. The power supply unit according to claim 2, wherein when the output voltage control line is set to be non-conductive, the pin detecting circuit and the regulation generation circuit do not operate, so that the first comparison circuit compares the reference voltage signal with the voltage division performed on the first voltage detection signal by the first voltage division circuit to generate the first voltage control signal;
and the second comparison circuit compares the first current detection signal with the first reference voltage division signal generated by voltage division performed on the reference voltage signal by the first voltage division circuit to generate the first current control signal.

4. The power supply unit according to claim 2, wherein when the output voltage control line is set to be conductive, the control terminal is coupled to the control voltage, the pin detecting circuit sets the regulation generation circuit to operate, to connect in parallel a seventh resistor to the first voltage division circuit, so that the first comparison circuit compares the reference voltage signal with the voltage division performed on the first voltage detection signal by the first voltage division circuit connected in parallel to the seventh resistor to generate the first voltage control signal;
and to connect in parallel an eighth resistor to the first voltage division circuit and the first voltage stabilizing circuit, so that the second comparison circuit compares the first current detection signal with the first reference voltage division signal generated by the voltage division performed on the reference voltage signal by the first voltage division circuit connected in parallel to the eighth resistor to generate the first division control signal.

5. The power supply unit according to claim 1, further comprising:
a second feedback circuit, coupled to the first output terminal of the power conversion circuit to receive a second voltage detection signal, coupled to the current detection circuit to receive a second current detection signal, and coupled to the output control circuit to correspondingly generate a second control signal based on a setting of the output control circuit;
wherein the coupling circuit is coupled to the first feedback circuit and the second feedback circuit to receive the first control signal and the second control signal, and configured to generate the power conversion control signal based on the first control signal and the second control signal; and
wherein when the output voltage control line is set to be conductive, the control terminal of the output control circuit is coupled through the output voltage control line to the first output terminal for receiving the control voltage, the output control circuit sets the second control signal generated by the second feedback circuit, the first control signal and the second control signal sets the power conversion circuit to correspondingly generate the first output voltage, and the power conversion circuit has the first maximum output current; and when the output voltage control line is set to be non-conductive, the output control circuit sets the second feedback circuit to not operate.

6. The power supply unit according to claim 5, wherein the output control circuit further comprises:
a pin detecting circuit, coupled to the first output terminal and the control terminal; and
a regulation generation circuit, coupled to the pin detecting circuit and the first feedback circuit;
the first feedback circuit further comprises:
a first voltage division circuit, coupled to the first output terminal to receive the first voltage detection signal, coupled to a reference voltage signal and the regulation generation circuit, and configured to generate a first voltage division control signal;
a first voltage stabilizing circuit, coupled to the first voltage division circuit and the regulation generation circuit, and configured to generate a first current division control signal based on the reference voltage signal;
a first comparison circuit, coupled to the first voltage division circuit, and configured to compare the first voltage division control signal with the reference voltage signal to generate a first voltage control signal; and
a second comparison circuit, coupled to the first voltage stabilizing circuit, and configured to compare the first current division control signal with the first current detection signal to generate a first current control signal;
the second feedback circuit further comprises:
a second voltage division circuit, coupled to the first output terminal to receive the second voltage detection signal and coupled to the reference voltage signal, and configured to generate a second voltage division control signal;
a second voltage stabilizing circuit, coupled to the second voltage division circuit, and configured to generate a second current division control signal based on the reference voltage signal;
a third comparison circuit, coupled to the second voltage division circuit and the pin detecting circuit, and configured to, when the pin detecting circuit provides a working voltage, compare the second voltage division control signal with the reference voltage signal to generate a second voltage control signal; and
a fourth comparison circuit, coupled to the second voltage stabilizing circuit and the pin detecting circuit, and configured to, when the pin detecting circuit provides the working voltage, compare the second current division control signal with the second current detection signal to generate a second current control signal;
wherein the coupling circuit is coupled to the first comparison circuit, the second comparison circuit, the third comparison circuit and the fourth comparison circuit, and correspondingly generates the power conversion control signal based on the first voltage control signal and the first current control signal and/or based on the second voltage control signal and the second current control signal;
when the output voltage control line is set to be non-conductive, the pin detecting circuit, the regulation generation circuit and the second feedback circuit do not operate, so that the first voltage division circuit performs voltage division on the first voltage detection signal to generate the first voltage division control signal having a first level, and the first voltage stabilizing circuit generates a first current division control signal having a third level based on a first reference voltage division signal generated by voltage division of the reference voltage signal, so that the power conversion circuit correspondingly generates the second output voltage, and the power conversion circuit has the second maximum output current; and
when the output voltage control line is set to be conductive, the control terminal is coupled to the control voltage, the pin detecting circuit sets the regulation generation circuit to operate to change one or more resistance values of the regulation generation circuit coupled to the first feedback circuit, so that the first voltage division circuit performs voltage division on the first voltage detection signal to generate the first voltage division control signal having a second level, the first voltage stabilizing circuit generates the first current division control signal having a fourth level based on the first reference voltage division signal, so that the power conversion circuit correspondingly generates the first output voltage, and the power conversion circuit has the first maximum output current; and the pin detecting circuit provides the working voltage to the second feedback circuit, so that the second voltage division circuit performs voltage division on the second voltage detection signal to generate the second voltage division control signal having the second level, and the second voltage stabilizing circuit generates the second current division control signal having the fourth level based on a second reference voltage division signal generated by the voltage division of the reference voltage signal.

7. The power supply unit according to claim 6, wherein when the output voltage control line is set to be non-conductive, the pin detecting circuit, the regulation generation circuit and the second feedback circuit do not operate, so that the first comparison circuit compares the reference voltage signal with the voltage division performed on the first voltage detection signal by the first voltage division circuit to generate the first voltage control signal;
and the second comparison circuit compares the first current detection signal with the first reference voltage division signal generated by the voltage division performed on the reference voltage signal by the first voltage division circuit to generate the first current control signal.

8. The power supply unit according to claim 6, wherein when the output voltage control line is set to be conductive, the control terminal is coupled to the control voltage, the pin detecting circuit sets the regulation generation circuit to operate, to connect in parallel a seventh resistor to the first voltage division circuit, so that the first comparison circuit compares the reference voltage signal with the voltage division performed on the first voltage detection signal by the first voltage division circuit connected in parallel to the seventh resistor to generate the first voltage control signal;
and to connect in parallel an eighth resistor to the first voltage division circuit and the first voltage stabilizing circuit, so that the second comparison circuit compares the first current detection signal with the first reference voltage division signal generated by the voltage division performed on the reference voltage signal by the first voltage division circuit connected in parallel to the eighth resistor to generate the first current control signal;
the pin detecting circuit provides the working voltage to the third comparison circuit and the fourth comparison circuit, so that the third comparison circuit compares the reference voltage signal with the voltage division performed on the second voltage detection signal by the second voltage division circuit to generate the second voltage control signal; and the fourth comparison circuit compares the second current detection signal with the second reference voltage division signal generated by the voltage division performed on the reference voltage signal by the second voltage division circuit to generate the second current control signal.

9. The power supply unit according to claim 6, wherein the second voltage division circuit performs voltage division on the second voltage detection signal to generate the second voltage division control signal having the second level, and the first voltage stabilizing circuit generates the second current division control signal having the fourth level based on the second reference voltage division signal, so that the power conversion circuit correspondingly generates the first output voltage and has the first maximum output current.

10. An operating method of a power supply unit, configured to supply power to a load, the power supply unit comprising a housing, an output voltage control line, a power conversion circuit, an output control circuit, a current detection circuit, a first feedback circuit, a coupling circuit and a power conversion control circuit, the housing accommodating at least one of the power conversion circuit, the output control circuit, the current detection circuit, the first feedback circuit, the coupling circuit, and the power conversion control circuit, the power conversion circuit comprising a first input terminal, a second input terminal, a first output terminal and a second output terminal, the first output terminal and the second output terminal being configured to be coupled to the load, the output control circuit being coupled to the first output terminal and having a control terminal, the current detection circuit comprising a first terminal coupled to the second output terminal of the power conversion circuit and a second terminal configured to be coupled to the load, the first feedback circuit being coupled to the first output terminal of the power conversion circuit, the current detection circuit and the output control circuit, the coupling circuit being coupled to the first feedback circuit, the power conversion control circuit being coupled to the coupling circuit and the power conversion circuit, the output voltage control line being coupled between the control terminal of the output control circuit and the first output terminal of the power conversion circuit, wherein at least a portion of the output voltage control line is exposed from the housing, the operating method comprising:
setting the first input terminal and the second input terminal of the power conversion circuit to receive an input voltage to supply, at the first output terminal and the second output terminal of the power conversion circuit, power to a load;
setting the first feedback circuit to receive a first voltage detection signal from the first output terminal of the power conversion circuit and to receive a first current detection signal from the current detection circuit to correspondingly generate a first control signal;
setting the coupling circuit to receive the first control signal from the first feedback circuit and to generate a power conversion control signal based on the first control signal; and
setting the power conversion control circuit to generate a conversion signal based on the power conversion control signal;
wherein when the output voltage control line is set to be conductive, the control terminal of the output control circuit is coupled through the output voltage control line to the first output terminal for receiving a control voltage, the output control circuit sets the first feedback circuit to generate the first control signal and the first control signal sets the power conversion circuit to correspondingly generate a first output voltage, and the power conversion circuit has a first maximum output current;
when the output voltage control line is set to be non-conductive, the output control circuit sets the first feedback circuit to generate the first control signal and the first control signal sets the power conversion circuit to correspondingly generate a second output voltage, and the power conversion circuit has a second maximum output current; and
the first output voltage is greater than the second output voltage, and the first maximum output current is less than the second maximum output current.

11. The operating method according to claim 10, wherein the output control circuit further comprises a pin detecting circuit and a regulation generation circuit, the pin detecting circuit is coupled to the first output terminal and the control terminal, the regulation generation circuit is coupled to the pin detecting circuit and the first feedback circuit, the first feedback circuit further comprises a first voltage division circuit, a first voltage stabilizing circuit, a first comparison circuit and a second comparison circuit, the first voltage division circuit is coupled to the first output terminal, a reference voltage signal and the regulation generation circuit, the first voltage stabilizing circuit is coupled to the first voltage division circuit and the regulation generation circuit, the first comparison circuit is coupled to the first voltage division circuit, the second comparison circuit is coupled to the first voltage stabilizing circuit, the power supply unit comprises a second feedback circuit, the second feedback circuit comprises a second voltage division circuit, a second voltage stabilizing circuit, a third comparison circuit and a fourth comparison circuit, the second voltage division circuit is coupled to the first output terminal and the reference voltage signal, the second voltage stabilizing circuit is coupled to the second voltage division circuit, the third comparison circuit is coupled to the second voltage division circuit and the pin detecting circuit, and the fourth comparison circuit is coupled to the second voltage stabilizing circuit and the pin detecting circuit, the operating method comprises:
setting the first voltage division circuit to receive the first voltage detection signal from the first output terminal of the power conversion circuit, and to generate a first voltage division control signal based on the reference voltage signal and the first voltage detection signal;
setting the first voltage stabilizing circuit to generate a first current division control signal based on the reference voltage signal;
setting the first comparison circuit to generate a first voltage control signal based on the first voltage division control signal and the reference voltage signal; and
setting the second comparison circuit to generate a first current control signal based on the first current division control signal and the first current detection signal;
setting the second voltage division circuit to receive a second voltage detection signal from the first output terminal of the power conversion circuit, and to generate a second voltage division control signal based on the reference voltage signal and the second voltage detection signal;
setting the second voltage stabilizing circuit to generate a second current division control signal based on the reference voltage signal; and
when the pin detecting circuit provides a working voltage, setting the third comparison circuit to generate a second voltage control signal based on the second voltage division control signal and the reference voltage signal, and setting the fourth comparison circuit to generate a second current control signal based on the second current division control signal and a second current detection signal;
wherein the coupling circuit is coupled to the first comparison circuit, the second comparison circuit, the third comparison circuit and the fourth comparison circuit, and correspondingly generates the power conversion control signal based on the first voltage control signal and the first current control signal and/or based on the second voltage control signal and the second current control signal;
when the output voltage control line is set to be non-conductive, the pin detecting circuit and the regulation generation circuit do not operate, so that the first voltage division circuit performs voltage division on the first voltage detection signal to generate the first voltage division control signal having a first level, and the first voltage stabilizing circuit generates a first current division control signal having a third level based on a first reference voltage division signal generated by voltage division of the reference voltage signal, so that the power conversion circuit correspondingly generates the second output voltage, and the power conversion circuit has the second maximum output current; and
when the output voltage control line is set to be conductive, the control terminal is coupled to the control voltage, the pin detecting circuit sets the regulation generation circuit to operate to change one or more resistance values of the regulation generation circuit coupled to the first feedback circuit, so that the first voltage division circuit performs voltage division on the first voltage detection signal to generate the first voltage division control signal having a second level, the first voltage stabilizing circuit generates the first current division control signal having a fourth level based on the first reference voltage division signal, so that the power conversion circuit correspondingly generates the first output voltage, and the power conversion circuit has the first maximum output current; and the pin detecting circuit provides the working voltage to the second feedback circuit, so that the second voltage division circuit performs voltage division on the second voltage detection signal to generate the second voltage division control signal having the second level, and the second voltage stabilizing circuit generates the second current division control signal having the fourth level based on a second reference voltage division signal generated by the voltage division of the reference voltage signal.
